(19) United States
(12) Patent Application Publication
(10) Pub. No.: US 2009/0082243 A1
(43) Pub. Date: Mar. 26, 2009

(54) DETERGENT PARTICLE

(76) Inventors: Anju Deepali Massey Brooker, Newcastle/Tyne (GB); Alberto Martinez-Becares, Newcastle upon Tyne (GB); David William York, Newcastle upon Tyne (GB); Dan Xu, Newcastle/Tyne (GB); Gillian Margaret Hardy, Newcastle/Tyne (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/211,982

(22) Filed: Sep. 17, 2008

(30) Foreign Application Priority Data
Sep. 24, 2007 (EP) 07117091.4

(51) Int. Cl. C11D 7/02; B32B 1/00

(52) U.S. Cl. 510/220; 428/402

(57) ABSTRACT

A particle having a size of from about 50 to about 1,000 μm comprising a low-shear exfoliable nanoclay, the nanoclay having a primary particle size of from about 10 to about 300 nm. The invention also includes detergents comprising the particle and a process for making the particle.

### TECHNICAL FIELD

The present invention is in the field of detergent, in particular it relates to a particle comprising nanoclay, a detergent comprising the particle and a process for making the particle. The particle is particularly suitable for use in an automatic dishwashing detergent.

### BACKGROUND OF THE INVENTION

In the field of detergents and in particular in the field of automatic dishwashing the formulator is constantly looking for new cleaning actives capable of providing improved cleaning and enabling more environmentally friendly formulations.

U.S. Pat. No. 4,597,886 relates to an enzymatic dishwashing composition comprising an effective level of a layered clay, e.g. a synthetic hectorite. Clays are charged crystals having a layered structure. The top and bottom of the crystals are usually negatively charged and the sides are positively charged. Due to the dual-charged nature of clays, they tend to aggregate in solution to form large structures and gel, once the gel has been formed it can be very difficult and require high shear to go back to individual particles. This is particularly challenging from the process view point and also from the view point of keeping the material dispersed in the dishwasher wash liquor. The conditions in the dishwasher do not involve high shear and it would not be possible to reverse gel formation. Moreover, these structures may deposit on the washed load leaving an undesirable film on them. In particular the nanoclays tend to aggregate in the presence of calcium and magnesium found in the wash water. Nanoclays cannot be incorporated in detergents in the form of fine powders, in particular detergents in powder form, because they would give rise to segregation.

One of the objects of the invention is to incorporate nanoclay in a detergent composition. The detergent should be able to provide the nanoclay to the cleaning liquor in exfoliated form.

### SUMMARY OF THE INVENTION

According to a first aspect of the present invention, there is provided a particle (herein also referred to as “secondary particle”) having a particle size of from about 50 μm to about 1,200 μm, more preferably from about 200 μm to about 1,000 μm and especially from about 500 μm to about 900 μm. This particle size makes the particle optimum for incorporation in solid, in particular powder detergents.

The secondary particle comprises a low-shear exfoliable nanoclay (herein also referred to as “nanoparticle”). The nanoclay has a primary particle size of from about 10 nm to about 300 nm, preferably from about 20 nm to about 100 nm and especially form about 30 to about 90 nm. The primary particle size can be measured using a Malvern zetasizer instrument. The nanoclay particle size referred to herein is the z-average diameter, an intensity mean size.

The secondary particle is able to release nanoclay in exfoliated form, the nanoclay having a particle size of from about 10 nm to about 300 nm, preferably from about 20 nm to about 100 nm and especially form about 30 to about 90 nm in the main wash of a dishwasher. Regarding shape, the nanoclay of the particle of the invention may have any shape but preferred herein are nanoclays with disc-shape (i.e., flat circular shape). Without being bound by theory it is believed that the nanoclay cleans by penetrating the interface between the soiled substrate and the soil. Disc-shaped nanoclay is believed to penetrate more easily the interface and contribute to a more effective cleaning.

The particle of the invention is not only capable of delivering the nanoclay to the wash liquor but it also does it quickly, i.e., preferably a least 90% of nanoparticle is delivered to the wash liquor in exfoliated form in less than 10 minutes, preferably less than 5 minutes and especially less than 3 minutes, from the start of the main wash. It is advantageous to have the nanoclay in exfoliated form in the wash liquor as soon as possible. Thus the nanoclay can act for longer.

Whether a particle comprises a “low shear exfoliable nanoclay” can be tested by dissolving the particle in water at 30°, in particular by dissolving 0.5 grams of particles in 500 ml of water stirring at 150 rpm during 2 minutes, if the resultant solution is transparent, it can be said that the nanoclay is “low shear exfoliable”. Particles containing “non low shear exfoliable nanoclay” give rise to milky solutions under the above conditions.

The nanoclay used herein may be either naturally occurring (milled to the appropriate size if required) or synthetic. Preferred nanoclays for use in the present invention are natural or synthetic hectorites, montmorillonites and bentonites, and of these synthetic hectorites are especially preferred. Preferred for use herein is a synthetic hectorite commercially available under the name Laponite® RD. Synthetic hectorites, have been found better for cleaning than other nanoparticules.

It has been found that secondary particles comprising an alkalinity source and a nanoclay dispersant are capable of delivering nanoclay to the dishwasher wash liquor in exfoliated form and maintaining the nanoparticle in exfoliated form during the wash process. Preferably, the secondary particle comprises from about 5 to about 50%, preferably from 10 to 40% by weight of the particle on a dry basis of nanoclay. Preferably, the particle also comprises an alkalinity source in a preferred level of from about 5 to about 60%, preferably from 10 to about 40% by weight of the particle on a dry basis. It is also preferred that the particle comprises a nanoclay dispersant in a preferred level of from about 10 to about 60%, preferably from about 20 to about 40% by weight of the particle on a dry basis.

The dispersant helps to keep the nanoclay exfoliated during the process for making the particle and under use conditions, especially when the particle is used in hard water (hardness level greater than about 200 ppm (as CaCO₃)). Nanoclay dispersant is a compound capable of keeping the nanoclay dispersed in a solution having a pH of from about 9 to about 12, having an ionic strength of from about 0.01 to about 0.02 moles/l and containing at least 96 ppm of Ca2+, preferably at least 191 ppm of Ca2+ and more preferably at least 219 ppm of Ca2+. Whether the nanoclay is exfoliated or aggregated can be determined by measuring the particle size of the nanoclay in the solution. Preferably the nanoclay and the dispersant are in the particle in a weight ratio of from about 1:1 to about 1:10, preferably from about 1:2 to about 1:8. Flocculation or aggregation has been found to occur outside these ranges.

A preferred dispersant for use herein is a low molecular weight polyacrylate homopolymer, having a molecular weight of from about 1,000 to about 20,000, preferably from about 2,000 to about 8,000 and more preferably from about 3,000 to about 6,000. This kind of polymer is a particularly good nanoclay dispersant. Another preferred dispersant for use herein is an aminocarboxylate chelant, in particular MGDA (methyl glycine di-acetic acid) and GLDA (glutamic acid-N,N-diacetate).

In other preferred embodiments the dispersant is a mixture of a low molecular weight polyacrlyate homopolymer and a chelant, in particular an amino polycarboxylate chelant. It has been found that the combination of low molecular weight polyacrylates with amino polycarboxylate chelants is good not only in terms of keeping the nanoclay exfoliated but also in terms of soil removal. MGDA and GLDA have been found most suitable amino polycarboxylate chelants for use herein.

In preferred embodiments, the detergent of the invention comprises a detergency bleach. In other preferred embodiments, the detergent comprises a detergency enzyme. There seems to be a synergy, in terms of cleaning, when a wash solution comprises low level of nanoparticle and enzymes, in particular amylases. Excellent cleaning results, in particular in automatic dishwashing, are obtained even under cold conditions, i.e., below 60° C., preferably below 50° C. and especially below 40° C. Preferred enzyme for use herein includes proteases and amylases and especially combinations thereof.

According to the second aspect of the invention, there is provided a detergent composition, preferably an automatic dishwashing detergent composition comprising particles according to the invention. The particles have a weight geometric mean particle size of from about 50 μm to about 1200 μm, more preferably from about 200 μm to about 1000 μm and especially from about 500 μm to about 900 μm. Preferably the particles include low level of fines and coarse particles, in particular less than 10% by weight of the particles are above about 1400, more preferably about 1200 or below about 20, more preferably about 10 μm. Again, these particle size distributions have been found particularly suitable in terms of reducing segregation.

In preferred embodiments, the detergent is phosphate free, i.e., comprises less than about 10%, preferably less than about 5% and more preferably less than 1% by weight of the detergent of phosphate. Because phosphates are believed to adversely impact the environment, there has been a continuing effort to decrease phosphate use in detergent compositions and to provide phosphate-free dishwashing detergents.

According to the last aspect of the invention, there is provided a process for making the particle of the invention. The process comprises the steps of:
a) making an aqueous alkaline solution comprising a dispersant agent;
b) mixing the nanoclay with the solution resulting from step a); and
c) reducing the amount of water in the mixture resulting form step b).

Preferably, the alkaline solution is made by, firstly, dissolving the alkaline source in water. Then the dispersant agent is added to the alkaline solution, then the nanoclay is added to this solution under agitation to keep it in exfoliated form. This order of addition of ingredients has been found to be the most favourable from the nanoclay exfoliation point of view. Particles obtained from solutions obtained following this order of addition have been found very good in terms of delivery of the nanoclay in exfoliated form to the dishwashing wash liquor. The process of the present invention allows the production of particles having a high level of nanoclay.

The reduction of the amount of water is preferably achieved by spray-drying, preferably a size enlargement operation, more preferably agglomeration, follows the spray-drying in order to obtain particles having the claimed particle size.

Another preferred process for water reduction includes extrusion.

### DETAILED DESCRIPTION OF THE INVENTION

The present invention envisages a particle comprising a nanoclay, a detergent comprising the particle and a process for making the particle. The particle of the invention, releases nanoclay in exfoliated form in cleaning environments. The particle and detergent of the invention are particularly preferred in automatic dishwashing. The detergent provides excellent removal of tough food soils from cookware and tableware, in particular starchy soils. Excellent results have been achieved when the dishwashing liquor comprises nanoclay as main soil removal active, either in absence of or in combination with other cleaning actives (such as enzymes, builders, surfactants, etc). This obviates or reduces the use of traditional dishwashing detergents. The compositions are free of phosphate builders.

Preferably the detergent of the invention gives rise to a high pH and a low ionic strength in the wash liquor. Without being bound by theory, it is believed that the high pH contributes to the hydration of the nanoclay and the low ionic strength contributes to the dispersion of the nanoclay. The combination of high pH and low ionic strength contributes to maintain the nanoclay in exfoliated form, avoiding aggregation, thereby improving cleaning.

Preferably the detergent has a pH of from about 9 to about 12, more preferably from about 10 to about 11.5, as measured in a 1% by weight aqueous solution at 25° C. Preferably the detergent provides the wash liquor with an ionic strength of from about 0.001 to about 0.02, more preferably from about 0.002 to about 0.015, especially form about 0.005 to about 0.01 moles/l. The detergent provides excellent cleaning, in particular on starch containing soils. Heavily soiled items such as those containing burn-on, baked-on or cook-on starchy food such as pasta, rice, potatoes, wholemeal, sauces thickened by means of starchy thickeners, etc. are easily cleaned using the method of the invention.

A composition that has been found to give excellent results comprises from about 2 to 60%, preferably from 5 to 50% by weight of the composition of nanoclay, from about 1 to about 40%, preferably from about 5 to about 35% by weight of the composition of an alkalinity source, from about 10 to about 60%, preferably from about 20 to about 50% by weight of the composition of a nanoclay dispersant, from about 5 to about 40%, preferably from about 10 to about 30% by weight of the composition of bleach and from about 0.5 to about 10%, preferably from about 0.01 to about 2% by weight of the composition of active enzyme.

Nanoclay

The nanoclay suitable for use herein has a particle size (z-average diameter) of from about 10 nm to about 300 nm, preferably from about 20 nm to about 100 nm and especially form about 30 to about 90 nm.

The layered clay minerals suitable for use in the present invention include those in the geological classes of the smectites, the kaolins, the illites, the chlorites, the attapulgites and the mixed layer clays. Smectites, for example, include montmorillonite, bentonite, pyrophyllite, hectorite, saponite, sauconite, nontronite, talc, beidellite, volchonskoite and vermiculite. Kaolins include kaolinite, dickite, nacrite, antigorite, anauxite, halloysite, indellite and chrysotile. illites include bravaisite, muscovite, paragonite, phlogopite and biotite. Chlorites include corrensite, penninite, donbassite, sudoite, pennine and clinochlore. Attapulgites include sepiolite and polygorskyte. Mixed layer clays include allevardite and vermiculitebiotite.

The nanoclay of the present invention may be either naturally occurring or synthetic. Some embodiments of the present invention may use natural or synthetic hectorites, montmorillonites and bentonites. Especially preferred are synthetic hectorites clays. Typical sources of commercial hectorites are the LAPONITES from Rockwood Additives Limited or Southern Clay Products, Inc., U.S.A.; Veegum Pro and Veegum F from R. T. Vanderbilt, U. S.A.; and the Barasyms, Macaloids and Propaloids from Baroid Division, National Read Comp., U.S.A.

Natural Clays

Natural clay minerals typically exist as layered silicate minerals and less frequently as amorphous minerals. A layered silicate mineral has SiO4 tetrahedral sheets arranged into a two-dimensional network structure. A 2:1 type layered silicate mineral has a laminated structure of several to several tens of silicate sheets having a three layered structure in which a magnesium octahedral sheet or an aluminium octahedral sheet is sandwiched between two sheets of silica tetrahedral sheets.

A sheet of an expandable layer silicate has a negative electric charge, and the electric charge may be neutralized by the existence of alkali metal cations and/or alkaline earth metal cations.

Synthetic Clays

With appropriate process control, the processes for the production of synthetic nanoscale powders (i.e. synthetic clays) does indeed yield primary particles, which are nanoscale. The production of nanoscale powders such as layered hydrous silicate, layered hydrous aluminium silicate, fluorosilicate, mica-montmorillonite, hydrotalcite, lithium magnesium silicate and lithium magnesium fluorosilicate are common

Synthetic hectorite was first synthesized in the early 1960's and is now commercially marketed under the trade name LAPONITE by Rockwood Additives Limited and Southern Clay Products, Inc. There are many grades or variants and isomorphous substitutions of LAPONITE marketed. Examples of commercial hectorites are Lucentite SWN, LAPONITE S, LAPONITE XLS, LAPONITE RD and LAPONITE RDS. Preferred for use herein is Laponite RD.

The ratio of the largest dimension of a particle to the smallest dimension of a particle is known as the particle's aspect ratio. The aspect ratio of the particles in a dispersed medium can be considered to be lower where several of the particles are aggregated than in the case of individual particles. The aspect ratio of dispersions can be adequately characterized by TEM (transmission electron microscopy). A high aspect ratio is desirable for the nanoclay for use herein. Preferably the aspect ratio of the nanoclay in the wash liquor is from 5 to about 35, preferably from about 10 to about 20.

Ionic Strength

Preferably the wash liquor has an ionic strength of from about 0.001 to about 0.02, more preferably from about 0.002 to about 0.015, especially form about 0.005 to about 0.01 moles/l. Ionic strength is calculated from the molarity (m) of each ionic species present in solution and the charge (z) carried by each ionic species. Ionic strength (I) is one half the summation of m.z² for all ionic species present i.e.

I=½Σm.z²

For a salt whose ions are both univalent, ionic strength is the same as the molar concentration. This is not so where more than two ions or multiple charges are involved. For instance a 1 molar solution of sodium carbonate contains 2 moles/litre of sodium ions and 1 mole/litre of carbonate ions carrying a double charge. Ionic strength is given by:

I=½[2(1²)+1×(2²)]=3 moles/litre

Alkalinity Source

Examples of alkalinity source include, but are not limited to, an alkali hydroxide, alkali hydride, alkali oxide, alkali sesquicarbonate, alkali carbonate, alkali borate, alkali salt of mineral acid, alkali amine, alkaloid and mixtures thereof. Sodium carbonate, sodium and potassium hydroxide are preferred alkalinity sources for use herein, in particular potassium hydroxide. The alkalinity source is present in an amount sufficient to give the wash liquor a pH of from about 9 to about 12, more preferably from about 10 to about 11.5.

Chelant

Suitable chelant (also herein referred to as chelating agent) to be used herein may be any chelating agent known to those skilled in the art such as the ones selected from the group comprising phosphonate chelating agents, amino carboxylate chelating agents or other carboxylate chelating agents, or polyfunctionally-substituted aromatic chelating agents or mixtures thereof.

Such phosphnate chelating agents may include etidronic acid (1-hydroxyethylidene-bisphosphonic acid or HEDP) as well as amino phosphonate compounds, including amino alkylene poly (alkylene phosphonate), alkali metal ethane 1-hydroxy diphosphonates, nitrilo trimethylene phosphonates, ethylene diamine tetra methylene phosphonates, and diethylene triamine penta methylene phosphonates. The phosphonate compounds may be present either in their acid form or as salts of different cations on some or all of their acid functionalities. Preferred phosphonate chelating agents to be used herein are diethylene triamine penta methylene phosphonates. Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

Suitable amino carboxylate chelating agents useful herein include nitrilotriacetates (NTA), ethylene diamine tetra acetate (EDTA), diethylene triamine pentacetate (DTPA), N-hydroxyethylethylenediamine triacetate, nitrilotri-acetate, ethylenediamine tetraproprionate, triethylenetetraaminehexa-acetate (HEDTA), triethylenetetraminehexaacetic acid (TTHA), propylene diamine tetracetic acid (PDTA) and, both in their acid form, or in their alkali metal salt forms. Particularly suitable to be used herein are diethylene triamine penta acetic acid (DTPA) and propylene diamine tetracetic acid (PDTA). A wide range of aminocarboxylate chelating agents is commercially available from BASF under the trade name Trilon®. A preferred biodegradable amino carboxylate chelating agent for use herein is ethylene diamine N,N′-disuccinic acid (EDDS), or alkali metal or alkaline earth salts thereof or mixtures thereof. Ethylenediamine N,N′-disuccinic acids, especially the (S,S) isomer have been extensively described in U.S. Pat. No. 4,704,233, Nov. 3, 1987 to Hartman and Perkins. Ethylenediamine N,N′-disuccinic acid is, for instance, commercially available under the tradename ssEDDS® from Palmer Research Laboratories.

Aminodicarboxylic acid-N,N-dialkanoic acid or its salt are also suitable amino carboxylate chelanting agents for use herein. The compounds can be represented by the following formula:

MOOC—CHZ¹-NZ²Z³

wherein each of Z¹, Z² and Z³ independently represents a COOM-containing group; wherein each of M independently represents either of a hydrogen atom, sodium, potassium or amine ion.

In the above formula, Z¹, Z² and Z³ may either be same with or different from each other, and examples of those groups are found among carboxymethyl group, 1-carboxyethyl group, 2-carboxyethyl group, 3-carboxypropan-2-yl group, their salts, etc. As concrete examples, there are glutamic acid-N,N-diacetic acid, glutamic acid-N,N-dipropionic acid, and their salts. Above all, glutamic acid-N,N-diacetate is especially preferred, in particular L-glutamic acid-N,N-diacetate.

Other suitable chelating agents include ethanoldiglycine and methyl glycine di-acetic acid (MGDA).

Further carboxylate chelating agents useful herein include low molecular weight hydrocarboxylic acids, such as citric acid, tartaric acid malic acid, lactic acid, gluconic acid, malonic acid, salicylic acid, aspartic acid, glutamic acid, dipicolinic acid and derivatives thereof, or mixtures thereof.

Polymer

Suitable polymers acting as nanoclay dispersant include polymeric polycarboxylated polymers, including homopolymers and copolymers. Preferred for use herein are low molecular weight (from about 2,000 to about 10,000, preferably from about 3,000 to about 6,000) homopolymers of acrylic acid. They are commercially available from BASF under the Sokalan PA range. An especially preferred material is Sokalan PA 30. Sodium polyacrylate having a nominal molecular weight of about 4,500, is obtainable from Rohm & Haas under the tradename ACUSOL® 445N. Other polymeric polycarboxylated polymers suitable for use herein include copolymers of acrylic acid and maleic acid, such as those available from BASF under the name of Sokalan CP and AQUALIC® ML9 copolymers (supplied by Nippon Shokubai Co. LTD).

Other suitable polymer dispersants for use herein are polymers containing both carboxylate and sulphonate monomers, such as ALCOSPERSE® polymers (supplied by Alco) and Acusol polymers (supplied by Rohm & Hass), in particular accusol 588 .

Polyethylene imine polymers are also useful in the method of the invention. This kind of polymer is available from BASF under the Lupasol tradename.

With reference to the polymers described herein, the term weight-average molecular weight (also referred to as molecular weight) is the weight-average molecular weight as determined using gel permeation chromatography according to the protocol found in Colloids and Surfaces A. Physico Chemical & Engineering Aspects, Vol. 162, 2000, pg. 107-121. The units are Daltons.

Process

The process of the invention is generally initiated by making an alkaline solution by dissolving the alkaline agent in water. Preferably the resulting solution has a pH of from about 9 to about 11, preferred alkaline agents for use herein include sodium carbonate, sodium hydroxide and potassium hydroxide. The dispersant agent is then added to the alkaline solution, preferably, the dispersant is a low molecular weight polyacrylate, an aminocarboxylate chelant or mixtures thereof. Preferred aminocarboxylate chelants are MGDA (methyl glycine di-acetic acid) and GLDA (glutamic acid-N,N-diacetate) or mixtures thereof. The nanoclay is added once the dispersant agent is dispersed in the solution to form a slurry. The nanoclay is usually added in solid form, usually containing a high level of water. The level of water in the slurry depends on the water reduction equipment used.

Synthetic nanoclay can be made by combining salts of sodium, magnesium and lithium with sodium silicate at carefully controlled rates and temperatures. This produces an amorphous precipitate which is then partially crystallised by a high temperature treatment. The resulting product is filtered, washed, dried and milled to a fine white powder. The filter cake resulting from this process can be directly added to the alkaline solution comprising the dispersant agent, thereby reducing the number of steps need it to obtain the nanoclay.

The process of the invention also requires water reduction from the resulting nanoclay containing slurry. Preferably, the slurry is dried to form a powder. The preferred drying method is spray-drying, but other methods such as air drying, oven drying, drum drying, ring drying, freeze drying, solvent drying or microwave drying may also be used. Extrusion can also be used as water reduction method.

Spray drying as a processing technique has and continues to find widespread use as a method for producing powders. It creates relatively porous particles which dissolve easily, even at low temperatures. Many patents and publications are available on spray drying. An overview article for detergent powders can be found in Powdered Detergents vol 71 (Surfactant Science Series) ed M Showell, ISBN 0-8247-9988-7, which includes a general overview of production methods and includes on p25, a schematic of slurry preparation and spray drying (coutesy Ballestra SPA), and Formulating Detergents and Personal Care Products. Ho Tan Tai. AOCS Press ISBN 1-893997-10-3.

Spray drying processes for forming detergent compositions are well known in the art and typically involve the steps of forming a slurry, often warmed to 60-80° C. The slurry has typically a water content of between 30%-60%. The slurry of the invention comprises an alkalinity source, a dispersant polymer and the nanoclay, it can also comprises processing aids. The slurry is pumped to the top of a spray drying tower, and sprayed from nozzles in the tower to form atomized droplets. These compositions could also be prepared by continuous slurry making. By continuous slurry making is meant a process in which components are fed continuously and substantially simultaneously to a slurry making vessel while mixed slurry is removed to the spray tower at a rate which maintains an essentially constant volume in the vessel.

Hot air is pumped through the spray drying towers such that when the atomized droplets are sprayed into the hot air, they dry into a powder as the free moisture evaporates. The spray-dried granules thus formed are then collected at the bottom of the tower. The granules can then be agglomerated to create particles having the desired particle size. This may be achieved in the spray drying tower by adding some steam to the powder or separately in a fluidized bed.

There are various designs and scale of spray drying equipment and accessory equipment, for example co-current, counter current air flow etc. For those skilled in the art, the selection of appropriate operating conditions and equipment will allow powders of acceptable quality to be produced using this invention on a particular spray drying tower.

Cleaning Actives

Any traditional cleaning ingredients can be used in the method, composition and product of the invention.

Bleach

Inorganic and organic bleaches are suitable cleaning actives for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate are preferred perhydrates for use herein. The percarbonate is most preferably incorporated into the products in a coated form which provides in-product stability. A suitable coating material providing in product stability comprises mixed salt of a water-soluble alkali metal sulphate and carbonate. Such coatings together with coating processes have previously been described in GB-1,466,799. The weight ratio of the mixed salt coating material to percarbonate lies in the range from 1:200 to 1:4, more preferably from 1:99 to 1 9, and most preferably from 1:49 to 1:19. Preferably, the mixed salt is of sodium sulphate and sodium carbonate which has the general formula Na2SO4.n.Na2CO3 wherein n is from 0.1 to 3, preferably n is from 0.3 to 1.0 and most preferably n is from 0.2 to 0.5.

Another suitable coating material providing in product stability, comprises sodium silicate of SiO2: Na20 ratio from 1.8:1 to 3.0:1, preferably L8:1 to 2.4:1, and/or sodium metasilicate, preferably applied at a level of from 2% to 10%, (normally from 3% to 5%) Of SiO2 by weight of the inorganic perhydrate salt. Magnesium silicate can also be included in the coating. Coatings that contain silicate and borate salts or boric acids or other inorganics are also suitable.

Other coatings which contain waxes, oils, fatty soaps can also be used advantageously within the present invention.

Potassium peroxymonopersulfate is another inorganic perhydrate salt of utility herein.

Typical organic bleaches are organic peroxyacids including diacyl and tetraacylperoxides, especially diperoxydodecanedioc acid, diperoxytetradecanedioc acid, and diperoxyhexadecanedioc acid. Dibenzoyl peroxide is a preferred organic peroxyacid herein. Mono- and diperazelaic acid, mono- and diperbrassylic acid, and Nphthaloylaminoperoxicaproic acid are also suitable herein.

The diacyl peroxide, especially dibenzoyl peroxide, should preferably be present in the form of particles having a weight average diameter of from about 0.1 to about 100 microns, preferably from about 0.5 to about 30 microns, more preferably from about 1 to about 10 microns. Preferably, at least about 25%, more preferably at least about 50%, even more preferably at least about 75%, most preferably at least about 90%, of the particles are smaller than 10 microns, preferably smaller than 6 microns. Diacyl peroxides within the above particle size range have also been found to provide better stain removal especially from plastic dishware, while minimizing undesirable deposition and filming during use in automatic dishwashing machines, than larger diacyl peroxide particles. The preferred diacyl peroxide particle size thus allows the formulator to obtain good stain removal with a low level of diacyl peroxide, which reduces deposition and filming. Conversely, as diacyl peroxide particle size increases, more diacyl peroxide is needed for good stain removal, which increases deposition on surfaces encountered during the dishwashing process.

Further typical organic bleaches include the peroxy acids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators if included in the compositions of the invention are in a level of from about 0.1 to about 10%, preferably from about 0.5 to about 2% by weight of the composition.

Bleach Catalyst

Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410). A complete description of bleach catalysts suitable for use herein can be found in WO 99/06521, pages 34, line 26 to page 40, line 16. Bleach catalyst if included in the compositions of the invention are in a level of from about 0.1 to about 10%, preferably from about 0.5 to about 2% by weight of the composition.

Surfactant

Preferably the compositions (methods and products) for use herein are free of surfactants. A preferred surfactant for use herein is low foaming by itself or in combination with other components (i.e. suds suppressers). Preferred for use herein are low and high cloud point nonionic surfactants and mixtures thereof including nonionic alkoxylated surfactants (especially ethoxylates derived from C₆-C₁₈ primary alcohols), ethoxylated-propoxylated alcohols (e.g., Olin Corporation's Poly-Tergent® SLF18), epoxy-capped poly(oxyalkylated) alcohols (e.g., Olin Corporation's Poly-Tergent® SLF18B—see WO-A-94/22800), ether-capped poly(oxyalkylated) alcohol surfactants, and block polyoxyethylene-polyoxypropylene polymeric compounds such as PLURONIC®, REVERSED PLURONIC®, and TETRONIC® by the BASF-Wyandotte Corp., Wyandotte, Mich.; amphoteric surfactants such as the C₁₂-C₂₀ alkyl amine oxides (preferred amine oxides for use herein include lauryldimethyl amine oxide and hexadecyl dimethyl amine oxide), and alkyl amphocarboxylic surfactants such as Miranol™ C2M; and zwitterionic surfactants such as the betaines and sultaines; and mixtures thereof. Surfactants suitable herein are disclosed, for example, in U.S. Pat. No. 3,929,678, U.S. Pat. No. 4,259,217, EP-A-0414 549, WO-A-93/08876 and WO-A-93/08874. Surfactants are typically present at a level of from about 0.2% to about 30% by weight, more preferably from about 0.5% to about 10% by weight, most preferably from about 1% to about 5% by weight of a detergent composition. Preferred surfactant for use herein, if any, are low foaming and include low cloud point nonionic surfactants and mixtures of higher foaming surfactants with low cloud point nonionic surfactants which act as suds suppresser therefor.

Enzyme

Enzymes suitable herein include bacterial and fungal cellulases such as Carezyme and Celluzyme (Novo Nordisk A/S); peroxidases; lipases such as Amano-P (Amano Pharmaceutical Co.), M1 Lipase^{R} and Lipomax^{R} (Gist-Brocades) and Lipolase^{R} and Lipolase Ultra^{R} (Novo); cutinases; proteases such as Esperase^{R}, Alcalase^{R}, Durazym^{R} and Savinase^{R} (Novo) and Maxatase^{R}, Maxacal^{R}, Properase^{R} and Maxapem^{R} (Gist-Brocades); and amylases such as Purafect Ox Am^{R} (Genencor) and Termamyl^{R}, Ban^{R}, Fungamyl^{R}, Duramyl^{R}, and Natalase^{R} (Novo); pectinases; and mixtures thereof. Enzymes are preferably added herein as prills, granulates, or cogranulates at levels typically in the range from about 0.0001% to about 5%, more preferably from about 0.001% to about 2% pure enzyme (also referred as active enzyme) by weight of the cleaning composition. Preferred for use herein are proteases, amylases and in particular combinations thereof.

Low Cloud Point Non-Ionic Surfactants and Suds Suppressers

The suds suppressers suitable for use herein include nonionic surfactants having a low cloud point. “Cloud point”, as used herein, is a well known property of nonionic surfactants which is the result of the surfactant becoming less soluble with increasing temperature, the temperature at which the appearance of a second phase is observable is referred to as the “cloud point” (See Kirk Othmer, pp. 360-362). As used herein, a “low cloud point” nonionic surfactant is defined as a nonionic surfactant system ingredient having a cloud point of less than 30° C., preferably less than about 20° C., and even more preferably less than about 10° C., and most preferably less than about 7.5° C. Typical low cloud point nonionic surfactants include nonionic alkoxylated surfactants, especially ethoxylates derived from primary alcohol, and polyoxypropylene/polyoxyethylene/polyoxypropylene (PO/EO/PO) reverse block polymers. Also, such low cloud point nonionic surfactants include, for example, ethoxylated-propoxylated alcohol (e.g., BASF Poly-Tergent® SLF18) and epoxy-capped poly(oxyalkylated) alcohols (e.g., BASF Poly-Tergent® SLF18B series of nonionics, as described, for example, in U.S. Pat. No. 5,576,281).

Preferred low cloud point surfactants are the ether-capped poly(oxyalkylated) suds suppresser having the formula:

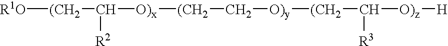

wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point nonionic surfactants are the ether-capped poly(oxyalkylated) having the formula:

R_{I}O(R_{II}O)ₙCH(CH₃)OR_{III}

wherein, R_{I} is selected from the group consisting of linear or branched, saturated or unsaturated, substituted or unsubstituted, aliphatic or aromatic hydrocarbon radicals having from about 7 to about 12 carbon atoms; R_{II} may be the same or different, and is independently selected from the group consisting of branched or linear C₂ to C₇ alkylene in any given molecule; n is a number from 1 to about 30; and R_{III} is selected from the group consisting of:
(i) a 4 to 8 membered substituted, or unsubstituted heterocyclic ring containing from 1 to 3 hetero atoms; and
(ii) linear or branched, saturated or unsaturated, substituted or unsubstituted, cyclic or acyclic, aliphatic or aromatic hydrocarbon radicals having from about 1 to about 30 carbon atoms;
(b) provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C₁ to C₅ alkyl.

Water-Soluble Pouch

The detergent composition of the invention can be in the form of a water-soluble pouch, more preferably a multi-phase unit dose pouch, preferably an injection-moulded, vacuum- or thermoformed multi-compartment, wherein at least one of the phases comprises the nanoclay. Preferred manufacturing methods for unit dose executions are described in WO 02/42408 and EP 1,447,343 B1. Any water-soluble film-forming polymer which is compatible with the compositions of the invention and which allows the delivery of the composition into the main-wash cycle of a dishwasher can be used as enveloping material.

Most preferred pouch materials are PVA films known under the trade reference Monosol M8630, as sold by Chris-Craft Industrial Products of Gary, Ind., US, and PVA films of corresponding solubility and deformability characteristics. Other films suitable for use herein include films known under the trade reference PT film or the K-series of films supplied by Aicello, or VF-HP film supplied by Kuraray.

Delayed Release

The detergent of the invention can benefit from delayed release of some ingredients, in particular nanoclay and enzymes. The nanoclay can negatively interact with some enzymes, in particular with proteases. It is convenient to have a delayed release of the nanoclay with respect to the enzyme. This ameliorates the negative interaction. By “delayed release” is meant that at least 50%, preferably at least 60% and more preferably at least 80% of one of the components is delivered into the wash solution at least one minute, preferably at least two minutes and more preferably at least 3 minutes, than at less than 50%, preferably less than 40% of the other component. The nanoparticle can be delivered first and the enzyme second or vice-versa. Good cleaning results are obtained when the enzyme, in particular protease, is delivered first and the nanoclay second. Delayed release can be achieved by for example using a multi-compartment pouch wherein different compartments have different dissolution rates, by having multi-phase tablets where different phases dissolve at different rates, having coated bodies, etc.

Delayed release can be achieved by means of coating, either by coating active materials or particle containing active material. The coating can be temperature, pH or ionic strength sensitive. For example particles with a core comprising either nanoclay or enzyme and a waxy coating encapsulating the core are adequate to provide delayed release. For waxy coating see WO 95/29982. pH controlled release means are described in WO 04/111178, in particular amino-acetylated polysaccharide having selective degree of acetylation.

Other means of obtaining delayed release are pouches with different compartments, where the compartments are made of film having different solubilities (as taught in WO 02/08380).

### EXAMPLES

Abbreviations Used in Examples

In the examples, the abbreviated component identifications have the following meanings:

| | |
|---|---|
| Laponite ® | Laponite ® RD synthetic hectorite available |
| | from Rockwood Additives Limited. |
| Carbonate | Anhydrous sodium carbonate. |
| PA30 | Polyacrylic acid available from BASF. |

The levels are quoted as parts by weight of the composition

| | |
|---|---|
| Example | 1 |
| Laponite | 8 |
| Carbonate | 10 |
| PA30 | 12 |
| Water | To balance |

A slurry is prepared by adding the above solid ingredients listed in example 1 to water. This is mixed using a high shear mixer (IKA high shear mixer). The slurry produced is then run through a Production Minor “Large” NIRO spray drier (conditions: Inlet temp: 220° C., Outlet temp: 125° C., Atomiser speed: 22000 rpm). The resulting powder is agglomerated to produce particles having 500 μm to about 9000 μm.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to the term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A particle having a size of from about 50 to about 1000 μm comprising a low-shear exfoliable nanoclay, the nanoclay having a primary particle size of from about 10 to about 300 nm.

2. A particle according to claim 1 wherein the nanoclay is a synthetic nanoclay.

3. A particle according to claim 1 wherein the level of nanoclay in the particle is from about 5 to about 50% by weight of the particle on a dry basis.

4. A particle according to claim 1 wherein the particle comprises an alkalinity source in a level of from about 1 to about 60% by weight of the particle on a dry basis.

5. A particle according to claim 1 wherein the particle comprises a nanoclay dispersant in a level of from about 10 to about 60% by weight of the particle on a dry basis.

6. A detergent composition comprising a particle according to claim 1.

7. A detergent composition according to claim 6 further comprising a detergency bleach.

8. A detergent composition according to claim 6 further comprising a detergency enzyme.

9. A detergent composition according to claim 6 wherein the composition is free of phosphate and has a pH as measured at 1% by weight aqueous solution at 25° C. of from about 9 to about 11.

10. A process for making a particle according to claim 1 comprising the steps of:
a) making an alkaline aqueous solution comprising a dispersing agent;
b) mixing the nanoclay with the solution resulting from step a); and
c) removing water from the mixture resulting from step b).
